(19) United States
(12) Patent Application Publication
(10) Pub. No.: US 2025/0003580 A1
(43) Pub. Date: Jan. 2, 2025

(54) FLAGPOLE BEACON FOR ILLUMINATION DURING LOW WIND CONDITIONS

(71) Applicant: Global Flags Unlimited LLC; dba The Flag Co., Acworth, GA (US)

(72) Inventor: Peter Mangal, Acworth, GA (US)

(21) Appl. No.: 18/217,583

(22) Filed: Jul. 2, 2023

(51) Int. Cl. F21V 21/30; F21V 21/116; F21V 33/00; G09F 17/00

(52) U.S. Cl. CPC F21V 21/30; F21V 21/116; F21V 33/006; G09F 17/00; G09F 2017/0025

(57) ABSTRACT

A device for illuminating a flag includes a truck that includes a bearing with an outer race portion. A lighting frame is affixed to the outer race portion so that it rotates with the outer race portion in a direction of the flag as it moves. The lighting frame includes a cylindrical portion terminating in a flat segment bottom portion and a planar surface intersects the cylindrical portion. A first pair of lighting elements is mounted on the planar surface of the lighting frame to cast a beam of light outwardly and downwardly to illuminate the flag when due to windy conditions. A second pair of lighting elements is mounted on the flat segment. Each of the second pair of lighting elements casts a beam of light that extends downwardly and parallel to the flagpole to illuminate the flag when the flag hangs downwardly due to non-windy conditions.

### BACKGROUND OF THE INVENTION

### 1. Field of the Invention

The present invention relates to flagpole accessories and, more specifically, to a flagpole illumination accessory.

### 2. Description of the Related Art

Some flag illumination systems for large flags of a type that are typically flown at commercial establishments direct light upwardly from the base of the flagpole to the flag. Such systems contribute to light pollution and can interfere with aviation.

One type of system directs light downwardly from the top of the flagpole. Some types of such systems direct a 360° cone of light from the top of the flagpole downwardly. However, such systems can also add to light pollution and can be irritating to people on the ground within the cone of light.

One solution to this problem is to mount a light source that generates a directed beam of light onto a rotating truck. The truck rotates in response to force applied to it by the lanyard to which the flag is attached so that when the wind changes direction, forcing the flag to fly in a different direction, the truck will rotate with the flag so that the directed beam illuminates the flag. One problem with this type of device is that when the wind is still and the flag droops down, the beam is directed above where the flag is and the flag will no longer be illuminated.

Also, such large flags are typically flown from a flagpole with an internal lanyard system, in which a lanyard that is coupled to a winch at the base of the flagpole extends through an internal channel defined by the flagpole to the top of the flagpole. A cover for the truck includes a pulley system that consists of two pulleys affixed to the top of the cover. The two pulleys direct the lanyard through an opening in the cover and the top of the flag is attached to the end of the lanyard. A weighted loop around the flagpole is attached to the bottom of the flag so that as the end of the lanyard is raised or lowered by rotating the winch, the flag is raised or lowered, respectively. Such a two pulley system, however, is typically limited to using narrow lanyards due to space limitations in the cover. This can be a problem when very large flags are employed as they can put so much force on a lanyard during windy conditions as to cause a narrow lanyard to fail. However, a typical dual pulley system cannot be fitted with a large lanyard.

Therefore, there is a need for a flag lighting system that illuminates a flag in both windy and still conditions.

Therefore, there is also a need for a flag lighting system that employs a pulley system that can accommodate multiple sizes of lanyards.

### SUMMARY OF THE INVENTION

The disadvantages of the prior art are overcome by the present invention which, in one aspect, is a device for illuminating a flag from a top of a flagpole in which the flagpole includes a lanyard system. The device includes a truck that includes: an elongated extension that is configured to be affixed to the top of the flagpole, the elongated extension including an inner race portion; an outer race portion disposed about the inner race portion; and a rolling element disposed between the inner race portion and the outer race portion so that the outer race portion rotates about the inner race portion. A lighting frame is affixed to the outer race portion so that the lighting frame rotates with the outer race portion in a direction of the flag as force is applied to the lighting frame from the lanyard. The lighting frame includes a substantially cylindrical portion terminating in a flat segment bottom portion. A planar surface intersects the cylindrical portion from a chord edge defined by the flat segment bottom portion at an obtuse angle from the flat segment bottom portion. A first pair of lighting elements is mounted on the planar surface of the lighting frame and each of first pair of lighting elements is configured to cast a beam of light radially outwardly at an angle from the flagpole and downwardly so as to illuminate the flag when the flag extends outwardly from the flagpole while subjected to windy conditions. A second pair of lighting elements is mounted on the flat segment of the lighting frame. Each of the second pair of lighting elements is configured to cast a beam of light that extends downwardly and parallel to the flagpole so as to illuminate the flag when the flag hangs downwardly along the flagpole while subjected to non-windy conditions.

In another aspect, the invention is a device for illuminating a flag from a top of a flagpole in which the flagpole includes a lanyard system in which a portion of a lanyard extends internally through the flagpole to the top of the flagpole. The device includes a truck, a lighting frame, a first pair of lighting elements, a second pair of lighting elements, a cover and a pulley system. The truck includes: an elongated extension that is configured to be affixed to the top of the flagpole, the elongated extension including an inner race portion; an outer race portion disposed about the inner race portion; and a rolling element disposed between the inner race portion and the outer race portion so that the outer race portion rotates about the inner race portion. The lighting frame is affixed to the outer race portion so that the lighting frame rotates with the outer race portion in a direction of the flag as force is applied to the lighting frame from the lanyard. The lighting frame includes a substantially cylindrical portion terminating in a flat segment bottom portion. A planar surface having a semi-elliptical shape intersects the cylindrical portion from a chord edge defined by the flat segment bottom portion at an obtuse angle from the flat segment bottom portion. The first pair of lighting elements is mounted on the planar surface of the lighting frame and each are configured to cast a beam of light radially outwardly at an angle from the flagpole and downwardly so as to illuminate the flag when the flag extends outwardly from the flagpole while subjected to windy conditions. The second pair of lighting elements is mounted on the flat segment of the lighting frame and each are configured to cast a beam of light that extends downwardly and parallel to the flagpole so as to illuminate the flag when the flag hangs downwardly along the flagpole while subjected to windy conditions. The elongated extension defines an elongated passage that is configured to allow passage of the lanyard from an internal portion of the flagpole therethrough. The flat segment defines a hole through which the elongated extension passes. The cover has a top and extends upwardly from the lighting frame. The cover protects the truck, an internal portion of the first pair of lighting elements and an internal portion of the second pair of lighting elements from outside elements. The pulley system consists of a single pulley that is coupled to the top of the cover. The single pulley is configured to support the lanyard received internally from the flagpole and supports movement of a portion of the lanyard through the opening defined by the planar surface. The planar structure of the lighting frame defines an inverted U-shape opening that is configured to allow a portion of the lanyard to pass from the single pulley through the opening to outside of the cover.

In yet another aspect, the invention is a method of illuminating a flag suspended from a flagpole, in which a first beam of light is directed radially outwardly from the flagpole and downwardly and at an angle from the flagpole so as to illuminate the flag when the flag is subjected to windy conditions. A second beam of light is directed downwardly and parallel to the flagpole so as to illuminate the flag when the flag is subjected to non-windy conditions.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a top left orthographic view of a low wind flagpole beacon showing my new design.

FIG. 2 is a bottom right view thereof.

FIG. 3 is a font elevational view thereof.

FIG. 4 is a left side elevational view thereof.

FIG. 5 is a right side elevational view thereof.

FIG. 6 is a back elevational view thereof.

FIG. 7 is a top plan view thereof.

FIG. 8 is a bottom plan view thereof.

FIG. 9 is a cross sectional view of the flagpole beacon shown in FIG. 5, taken along line 9-9.

FIG. 10A is a perspective view of a flagpole, a flagpole beacon and a flag in windy conditions.

FIG. 10B is a perspective view of a flagpole, a flagpole beacon and a flag in still conditions.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

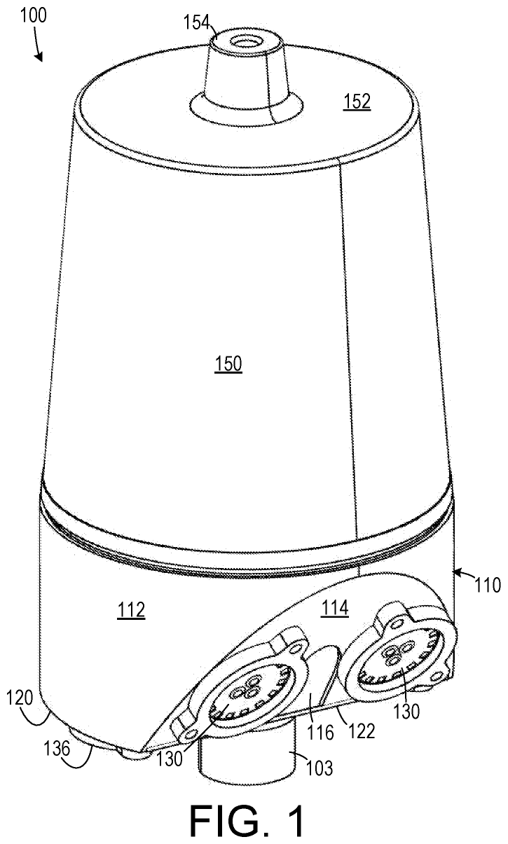

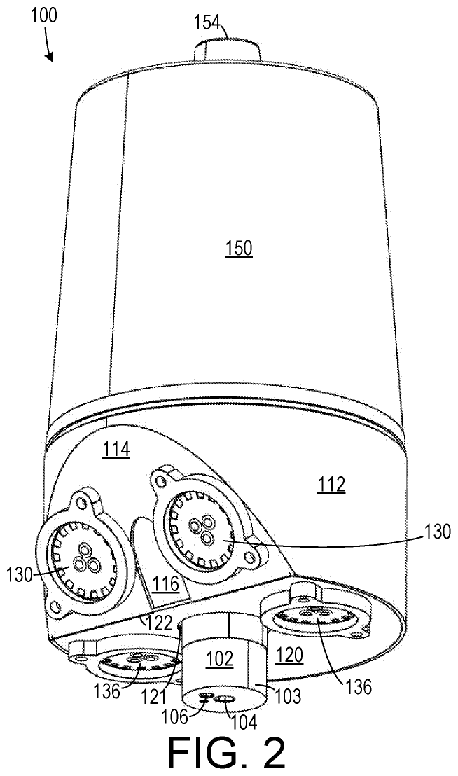

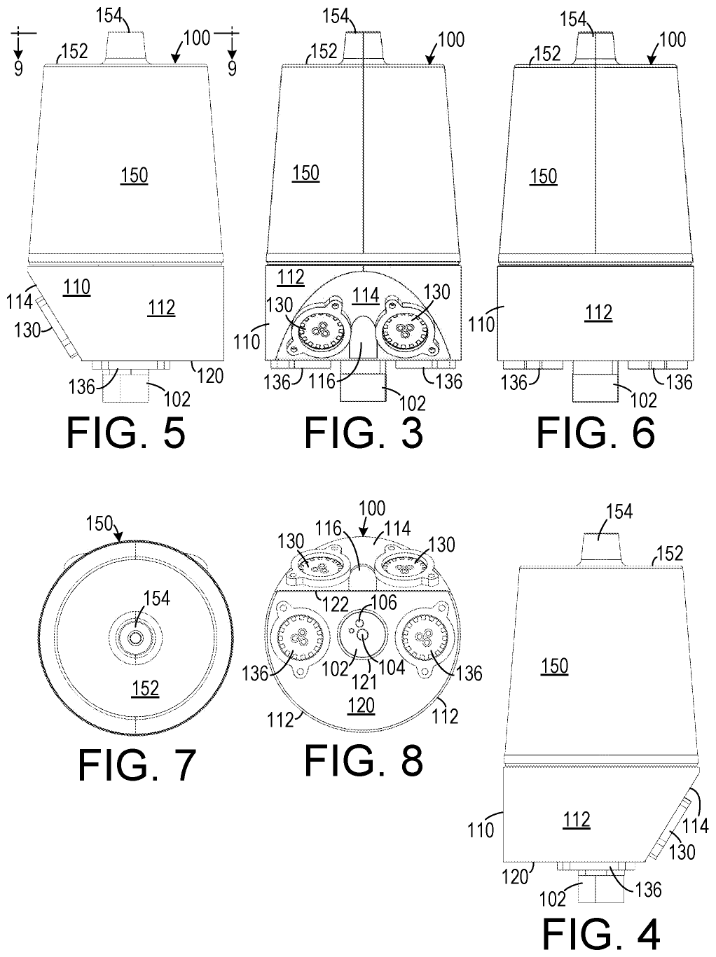

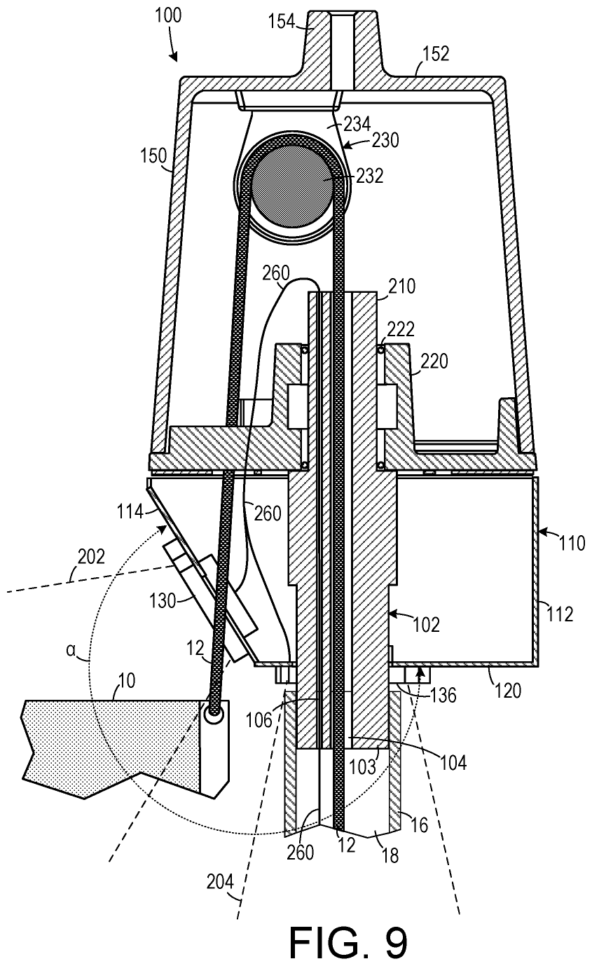

As shown in FIGS. 1-9, one embodiment of embodiment of a flagpole beacon 100 for illuminating a flag 10 that flies from a flagpole 16 includes a lighting frame 110 that is affixable to a cover 150 (typically with screws-not shown) and that is mounted on a rotatable truck 102, which is configured to be affixed to a flagpole 16. The truck 102 includes an elongated extension 103 that is configured to be affixed to the top of the flagpole 16. The elongated extension 103 includes an inner race portion 210 and an outer race portion 220 disposed about the inner race portion 210 to form a bearing. The bearing can, for example, include a sliding contact bearing or it can include a rolling element 222 (e.g., a ball bearing) disposed between the inner race portion 210 and the outer race portion 220 or, in certain embodiments, the bearing can include another type of bearing such as a sliding contact bearing. The outer race portion 220 rotates about the inner race portion 210.

The lighting frame 110 is affixed to the outer race portion 220 so that the lighting frame 110 rotates with the outer race portion 220 in a direction of the flag 10 as force is applied to the lighting frame 110 from a lanyard 12 to which the flag 10 is affixed. As a result, the lighting frame 110 will follow the flag 10 as wind direction changes. The lighting frame 110 includes a substantially cylindrical portion 112 that terminates in a flat segment bottom portion 120. A semi-elliptical planar surface 114 intersects the cylindrical portion 112 from a chord edge 122 defined by the flat segment bottom portion 120 at an obtuse angle α from the flat segment bottom portion 120. The planar surface 114 defines an inverted U-shaped opening 116 in communication with the interior of the lighting frame 110

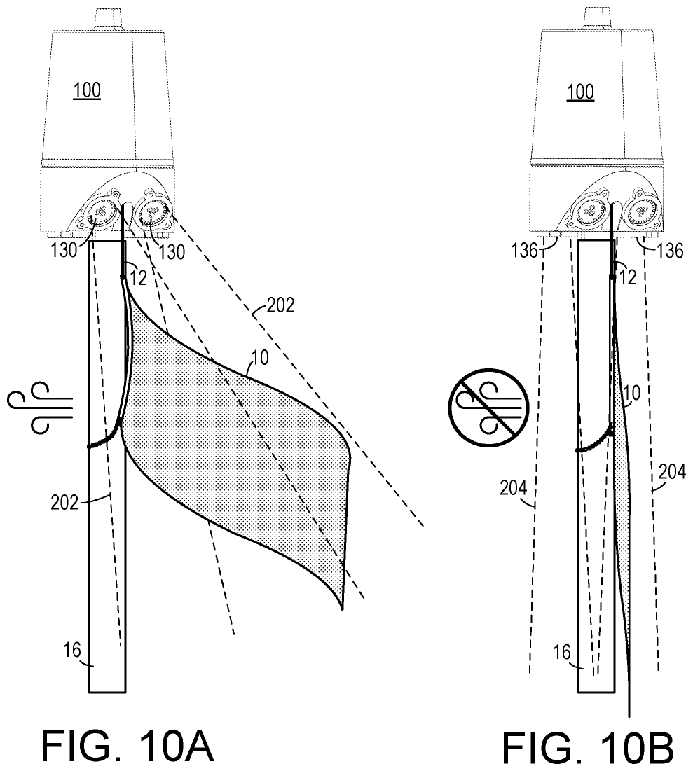

A first pair of lighting elements 130 is mounted on the planar surface 114 of the lighting frame 110. Each of the first pair of lighting elements 130 casts a beam of light 202 radially outwardly at an angle from the flagpole 16 and downwardly so as to illuminate the flag 10 when the flag extends outwardly from the flagpole 16 while subjected to windy conditions (as shown in FIG. 10A).

A second pair of lighting elements 136 is mounted on the flat segment bottom portion 120 of the lighting frame 110. Each of the second pair of lighting elements 136 casts a beam of light 204 that extends downwardly and parallel to the flagpole 16 so as to illuminate the flag 10 when the flag 10 hangs downwardly along the flagpole while subjected to non-windy conditions (as shown in FIG. 10B).

Both the first pair of lighting elements 130 and the second pair of lighting elements 136 can include arrays of high wattage light emitting diodes. Wires 260 running up through the interior 18 of the flagpole 16 through a passage 106 defined by the rotatable truck 102 can be used to power the light emitting diodes.

In certain embodiments, a portion of a lanyard 12 extends internally through the flagpole 16 to the top of the flagpole. In such embodiments, the elongated extension 103 defines an elongated passage 104 that allows passage of the lanyard 12 from an internal portion 18 of the flagpole 16 therethrough. The flat segment 120 defines a hole 121 through which the elongated extension passes 103. A frustoconical cover 150 (or other shaped cover) that has a top 152 extends upwardly from the lighting frame 110 and protects the truck 102, an internal portion of the first pair of lighting elements 130 and an internal portion of the second pair of lighting elements 136 from outside elements. A pulley system 230 consists of only a single pulley 232 that is coupled to the top 152 of the cover 150 via a pulley support structure 234. The single pulley 232 supports the lanyard 12 received internally from the flagpole 16 and supports movement of the lanyard 12 through the opening 116 defined by the planar surface 114. The single pulley 232 can support different widths of lanyard. A mount 154 for a finial can extend from the top 152 of the cover 150.

The light beams 202 and 204 will typically project a cone of light with a semi-vertical angle of less than 90° so that mainly the flag 10 is illuminated, thereby limiting the amount of light that is wasted. Also, one embodiment can include wind sensors that turn on only the lighting elements that are needed. For example, the system will turn on only the first lighting elements 130 when there is a sufficient amount of wind to extend the flag 10 fully outwardly and turn on only the second lighting elements 136 in still conditions when the flag 10 is drooping. In light wind, both sets of lighting elements 130 and 136 can be turned on. In embodiments without wind sensors, both sets of lighting elements 130 and 136 will be turned on simultaneously during normal operation.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(f) unless the words “means for” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A device for illuminating a flag from a top of a flagpole, the flagpole including a lanyard system, the device comprising:
(a) a truck that includes:
(i) an elongated extension that is configured to be affixed to the top of the flagpole, the elongated extension including an inner race portion; and
(ii) an outer race portion disposed about the inner race portion so as to be able to rotate thereabout;
(b) a lighting frame that is affixed to the outer race portion so that the lighting frame rotates with the outer race portion in a direction of the flag as force is applied to the lighting frame from the lanyard, the lighting frame including a substantially cylindrical portion terminating in a flat segment bottom portion, a planar surface intersecting the cylindrical portion from a chord edge defined by the flat segment bottom portion at an obtuse angle from the flat segment bottom portion;
(c) at least one first lighting element mounted on the planar surface of the lighting frame in which the first lighting element is configured to cast a beam of light radially outwardly at an angle from the flagpole and downwardly so as to illuminate the flag when the flag extends outwardly from the flagpole while subjected to windy conditions; and
(d) at least one second lighting element mounted on the flat segment bottom portion of the lighting frame in the second lighting element is configured to cast a beam of light that extends downwardly and parallel to the flagpole so as to illuminate the flag when the flag hangs downwardly along the flagpole while subjected to non-windy conditions.

2. The device for illuminating a flag of claim 1, wherein a portion of a lanyard extends internally through the flagpole to the top of the flagpole and wherein the elongated extension defines an elongated passage that is configured to allow passage of the lanyard from an internal portion of the flagpole therethrough and wherein the flat segment defines a hole through which the elongated extension passes, the device further comprising;
(a) a cover, having a top, extending upwardly from the lighting frame that protects the truck, an internal portion of the first pair of lighting elements and an internal portion of the second pair of lighting elements from outside elements; and
(b) a pulley system consisting of a single pulley that is coupled to the top of the cover, the single pulley configured to support the lanyard received internally from the flagpole and that supports movement of a portion of the lanyard through the opening defined by the planar surface.

3. The device for illuminating a flag of claim 2, wherein the planar surface defines an opening configured to allow a portion of the lanyard to pass from the single pulley through the opening to outside of the cover

4. The device for illuminating a flag of claim 3, wherein the opening defined by the planar surface has an inverted U-shape.

5. The device for illuminating a flag of claim 2, wherein the single pulley is configured to support different sizes of lanyards.

6. The device for illuminating a flag of claim 1, wherein the first lighting element comprises a pair of lighting elements that each include light emitting diodes.

7. The device for illuminating a flag of claim 1, wherein the second lighting element comprises a second pair of lighting elements that each include light emitting diodes.

8. The device for illuminating a flag of claim 1, wherein the planar surface has a semi- elliptical shape.

9. The device for illuminating a flag of claim 1, wherein the cover has a frustoconical shape.

10. A device for illuminating a flag from a top of a flagpole, the flagpole including a lanyard system in which a portion of a lanyard extends internally through the flagpole to the top of the flagpole, the device comprising:
(a) a truck that includes:
(i) an elongated extension that is configured to be affixed to the top of the flagpole, the elongated extension including an inner race portion;
(ii) an outer race portion disposed about the inner race portion; and
(iii) rolling element disposed between the inner race portion and the outer race portion so as to be able to rotate thereabout;
(b) a lighting frame that is affixed to the outer race portion so that the lighting frame rotates with the outer race portion in a direction of the flag as force is applied to the lighting frame from the lanyard, the lighting frame including a substantially cylindrical portion terminating in a flat segment bottom portion, a planar surface having a semi-elliptical shape intersecting the cylindrical portion from a chord edge defined by the flat segment bottom portion at an obtuse angle from the flat segment bottom portion;
(c) a first pair of lighting elements mounted on the planar surface of the lighting frame in which each of the first pair of lighting elements is configured to cast a beam of light radially outwardly at an angle from the flagpole and downwardly so as to illuminate the flag when the flag extends outwardly from the flagpole while subjected to windy conditions; and
(d) a second pair of lighting elements mounted on the flat segment bottom portion of the lighting frame in which each of the second pair of lighting elements is configured to cast a beam of light that extends downwardly and parallel to the flagpole so as to illuminate the flag when the flag hangs downwardly along the flagpole while subjected to windy conditions, wherein and wherein the elongated extension defines an elongated passage that is configured to allow passage of the lanyard from an internal portion of the flagpole therethrough and wherein the flat segment defines a hole through which the elongated extension passes;
(e) a cover, having a top, extending upwardly from the lighting frame that protects the truck, an internal portion of the first pair of lighting elements and an internal portion of the second pair of lighting elements from outside elements; and
(f) a pulley system consisting of a single pulley that is coupled to the top of the cover, the single pulley configured to support the lanyard received internally from the flagpole and that supports movement of a portion of the lanyard through the opening defined by the planar surface, wherein the planar structure of the lighting frame defines an inverted U-shape opening that is configured to allow a portion of the lanyard to pass from the single pulley through the opening to outside of the cover.

11. The device for illuminating a flag of claim 10, wherein the single pulley is configured to support different sizes of lanyards.

12. The device for illuminating a flag of claim 10, wherein the first pair of lighting elements comprises light emitting diodes.

13. The device for illuminating a flag of claim 10, wherein the second pair of lighting elements comprises light emitting diodes.

14. A method of illuminating a flag suspended from a flagpole, comprising the steps of:
(a) directing a first beam of light radially outwardly from the flagpole and downwardly and at an angle from the flagpole so as to illuminate the flag when the flag is subjected to windy conditions; and
(b) directing a second beam of light downwardly and parallel to the flagpole so as to illuminate the flag when the flag is subjected to non-windy conditions.

15. The method of claim 14, wherein the step of directing the first beam comprises generating light with first light source and wherein the step of directing the second beam comprises generating light with second light source that is different from the first light source.

16. The method of claim 15, further comprising the step of employing light emitting diodes in the first light source and in the second light source.

17. The method of claim 15, further comprising the steps of:
(a) mounting the first light source on a flat segment bottom portion that terminates a substantially cylindrical portion of a lighting frame; and
(b) mounting the second light source on a planar surface intersecting the cylindrical portion from a chord edge defined by the flat segment bottom portion at an obtuse angle from the flat segment bottom portion.

18. The method of claim 14, wherein the first beam of light and the second beam of light each comprises a cone of light with a semi-vertical angle of less than 90°.

19. The method of claim 14, wherein the flag is affixed to a lanyard, a portion of which passes internally through the flagpole, further comprising the step of supporting the lanyard by a single pulley that is supported by a top of a cover that is affixed to the lighting frame.

20. The method of claim 19, further comprising the step of selecting the single pulley such that the single pulley is configured to support different sizes of lanyards.
